(19) United States
(12) Patent Application Publication
(10) Pub. No.: US 2025/0337309 A1
(43) Pub. Date: Oct. 30, 2025

(54) SEMICONDUCTOR DEVICE

(71) Applicant: ROHM Co., Ltd., Kyoto (JP)

(72) Inventor: Kunimasa Tanaka, Kyoto (JP)

(73) Assignee: ROHM Co., Ltd., Kyoto (JP)

(21) Appl. No.: 19/096,687

(22) Filed: Mar. 31, 2025

(30) Foreign Application Priority Data
Apr. 30, 2024 (JP) 2024-073461

(51) Int. Cl. H02M 1/00; H02M 3/00

(52) U.S. Cl. CPC H02M 1/0006; H02M 1/0009; H02M 3/003

(57) ABSTRACT

A semiconductor device includes: an internal power supply circuit configured to generate an internal power supply voltage based on an input power supply voltage; a function circuit configured to operate based on the internal power supply voltage; a chassis accommodating the internal power supply circuit and the function circuit; a specific terminal that is a terminal exposed from the chassis and is configured to be applied with the internal power supply voltage; and a mode setting circuit configured to set an operation mode of the function circuit according to a terminal current flowing through the specific terminal.

### CROSS-REFERENCE TO RELATED APPLICATION

This application claims the priority benefit of Japan application serial no. 2024-073461, filed on Apr. 30, 2024. The entirety of the above-mentioned patent application is hereby incorporated by reference herein and made a part of this specification.

### BACKGROUND

### Technical Field

The disclosure relates to a semiconductor device.

### Related Art

A power supply device (see Patent Document 1: International Patent Publication No. 2021/054027) that generates an output voltage from an input voltage by power conversion may be formed using a semiconductor device. In the case of causing an operation content or a setting content to differ in the semiconductor device, a method of manufacturing and selling of multiple types of semiconductor devices with operation contents or setting contents different from each other is adopted or considered. Alternatively, another method is adopted or considered, in which one or more dedicated external terminals are provided at the semiconductor device, and the operation content or setting content is specified according to a difference in voltage level applied to the dedicated external terminal.

However, in the former method, since multiple types of semiconductor devices need to be manufactured as separate products, the burden of manufacturing and inventory management increases. In the latter method, the need for dedicated external terminals leads to increased component size and cost of the semiconductor device. In addition, due to a demand for miniaturization in recent years, it may be difficult to provide dedicated external terminals in the first place. In relation to causing the operation content or setting content to differ from each other, development of a technique that contributes to reducing the burden of manufacturing and inventory management or reducing the component size and cost is expected.

### SUMMARY

A semiconductor device according to an aspect of the disclosure includes: an internal power supply circuit configured to generate an internal power supply voltage based on an input power supply voltage; a function circuit configured to operate based on the internal power supply voltage; a chassis accommodating the internal power supply circuit and the function circuit; a specific terminal that is a terminal exposed from the chassis and is configured to be applied with the internal power supply voltage; and a mode setting circuit configured to set an operation mode of the function circuit according to a terminal current flowing through the specific terminal.

### BRIEF DESCRIPTION OF THE DRAWINGS

FIG. 1 is a schematic configuration block diagram of a power supply device according to an embodiment of the disclosure.

FIG. 2 is an external perspective view of a power supply control device according to the embodiment of the disclosure.

FIG. 3 is a diagram showing regulators of multiple channels provided in the power supply device according to the embodiment of the disclosure.

FIG. 4 is a diagram showing regulators of multiple channels provided in the power supply device according to the embodiment of the disclosure.

FIG. 5 is a configuration diagram of two regulators in the power supply device according to the embodiment of the disclosure.

FIG. 6 is a partial block diagram of the power supply control device according to the embodiment of the disclosure.

FIG. 7 is a partial block diagram of the power supply control device according to the embodiment of the disclosure.

FIG. 8 is a partial configuration diagram of the power supply control device according to a first example belonging to the embodiment of the disclosure.

FIG. 9 is a timing chart around the startup time of the power supply control device according to the first example belonging to the embodiment of the disclosure.

FIG. 10 is a diagram illustrating a decision method for a mode determination value according to the first example belonging to the embodiment of the disclosure.

FIG. 11 is a diagram illustrating a decision method for a mode determination value according to the first example belonging to the embodiment of the disclosure.

FIG. 12 is a timing chart around the startup time of the power supply control device according to a second example belonging to the embodiment of the disclosure.

FIG. 13 is a circuit diagram of a detection circuit that may be provided in a determination circuit according to a third example belonging to the embodiment of the disclosure.

FIG. 14 is a circuit diagram of a detection circuit that may be provided in the determination circuit according to the third example belonging to the embodiment of the disclosure.

FIG. 15 is a circuit diagram of a detection circuit that may be provided in the determination circuit according to the third example belonging to the embodiment of the disclosure.

FIG. 16 is a conceptual diagram of changing a generation sequence of output voltages according to a fourth example belonging to the embodiment of the disclosure.

FIG. 17 is a diagram showing devices connected via a communication bus according to the fourth example belonging to the embodiment of the disclosure.

### DETAILED DESCRIPTION

Hereinafter, examples of an embodiment of the disclosure will be specifically described with reference to the drawings. In each referenced figure, the same portions will be labeled with the same reference signs, and repeated descriptions about the same portions will be omitted in principle. In this specification, for simplification of description, by indicating symbols or reference signs that refer to information, signals, physical quantities, functional parts, circuits, elements, components, etc., names of the information, signals, physical quantities, functional parts, circuits, elements, components, etc. corresponding to the symbols or reference signs may be omitted or abbreviated.

First, several terms used in the description of the embodiment of the disclosure will be described. “Ground” refers to a reference conductor having a reference potential of 0 V (zero volts), or refers to the potential of 0 V itself. The reference conductor may be formed using a conductor such as metal. The potential of 0 V may also be called a ground potential. In the embodiment of the disclosure, a voltage indicated without specifying a reference represents a potential as viewed from ground. “Level” refers to the level of a potential, and for any signal or voltage of interest, high level has a higher potential than low level.

For any transistor configured as an FET (field-effect transistor) exemplified by a MOSFET, “on-state” refers to a state of conduction between the drain and the source of the transistor, and “off-state” refers to a state (cutoff state) of non-conduction between the drain and the source of the transistor. The same also applies to a transistor not classified as an FET.

Unless otherwise specified, a MOSFET is understood as an enhancement-type MOSFET. MOSFET is an abbreviation for “metal-oxide-semiconductor field-effect transistor”. In addition, unless otherwise specified, in any MOSFET, the back gate may be considered to be short-circuited to the source. Hereinafter, for any transistor, the on-state and the off-state may be simply expressed as “on” and “off”.

A connection between multiple parts forming a circuit, such as any circuit element, wiring, node, etc., may be understood to refer to electrical connection unless otherwise specified.

In the case where any two voltages to be compared are voltages v1 and v2, “v1>v2” indicates that the voltage v1 is higher than the voltage v2, “v1<v2” indicates that the voltage v1 is lower than the voltage v2, and “v1=v2” indicates that the value of the voltage v1 is the same as the value of the voltage v2. The same also applies to other formulas including physical quantities other than voltage.

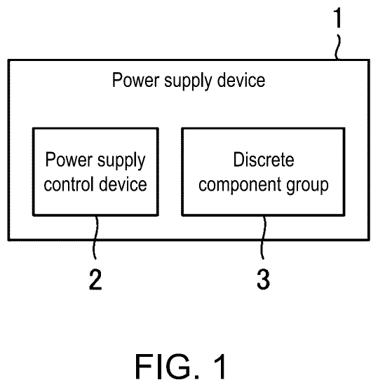

FIG. 1 is a schematic configuration block diagram of a power supply device 1 according to an embodiment of the disclosure. The power supply device 1 includes a power supply control device 2, and a discrete component group 3 composed of multiple discrete components externally connected to the power supply control device 2. The power supply control device 2 may be an electronic component classified as a PMIC (power management IC). A wiring provided inside the power supply control device 2 may be particularly referred to as an internal wiring, and a wiring provided outside the power supply control device 2 may be particularly referred to as an external wiring.

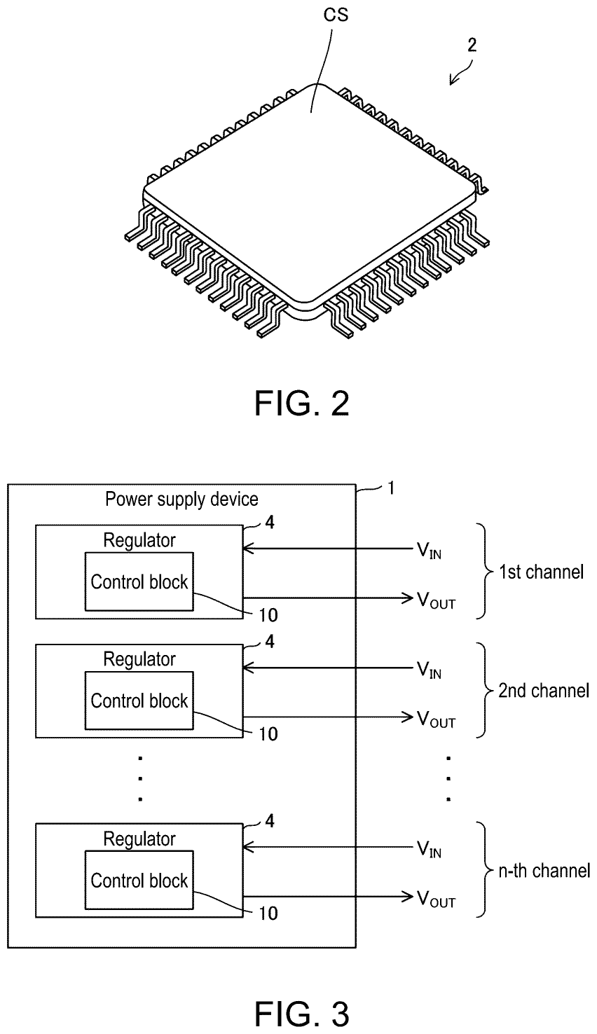

FIG. 2 shows an external perspective view of the power supply control device 2. The power supply control device 2 is an electronic component including a semiconductor chip having a semiconductor integrated circuit formed on a semiconductor substrate, a chassis CS (package) accommodating the semiconductor chip, and multiple external terminals exposed from the chassis CS to outside the power supply control device 2. The power supply control device 2 is formed by encapsulating the semiconductor chip in the chassis CS composed of resin. The number of external terminals of the power supply control device 2 and the type of the chassis CS of the power supply control device 2 shown in FIG. 2 are merely exemplary, and may be designed in any manner.

As shown in FIG. 3, the power supply device 1 is provided with regulators 4 for n channels, i.e., provided with n regulators 4. In the present embodiment, unless otherwise specified, n represents any integer of 2 or more. The regulators 4 for n channels may also be expressed as power supply devices for n channels, and in that case, the power supply device 1 may also be referred to as a composite power supply device having power supply devices (4) for n channels.

Each regulator 4 is provided with a control block 10. The n channels are composed of 1st to n-th channels. Each regulator 4 receives supply of an input voltage V_{IN}, and generates an output voltage V_{OUT} by performing power conversion on the input voltage V_{IN}. In each channel, the input voltage V_{IN} and the output voltage V_{OUT} are DC voltages different from each other. Although the input voltage V_{IN} or the output voltage V_{OUT} in each channel may be a negative DC voltage, hereinafter, the input voltage V_{IN} and the output voltage V_{OUT} in each channel are assumed to be positive DC voltages.

The regulators 4 of one or more channels in the 1st to n-th channels may be switching regulators. The regulator 4 as a switching regulator may be a step-down switching regulator that generates an output voltage V_{OUT} lower than the input voltage V_{IN} by stepping down the input voltage V_{IN}, or a step-up switching regulator that generates an output voltage V_{OUT} higher than the input voltage V_{IN} by stepping up the input voltage V_{IN}. The regulators 4 of one or more channels in the 1st to n-th channels may be linear regulators. The n regulators 4 in total in the 1st to n-th channels may all be switching regulators, or may all be linear regulators. Among the n regulators 4 in total in the 1st to n-th channels, one or more switching regulators and one or more linear regulators may also coexist.

The n output voltages V_{OUT} in total in the 1st to n-th channels are DC voltages different from each other. However, there may also be cases where the value of the output voltage V_{OUT}in the i_{A}-th channel coincides with the value of the output voltage V_{OUT} in the i_{B}-th channel. Herein, i_{A} and i_{B} represent any natural numbers of n or less different from each other.

The n input voltages V_{IN} in total in the 1st to n-th channels may be the same DC voltage as each other. That is, a common DC voltage may be shared as the input voltage V_{IN} for the 1st to n-th channels. The input voltage V_{IN} in the i_{A}-th channel may be the same as or different from the input voltage V_{IN} in the i_{B}-th channel. The input voltage V_{IN} of any channel of the 1st to n-th channels may be a power supply voltage (power supply voltage VCC to be described later) of the power supply control device 2.

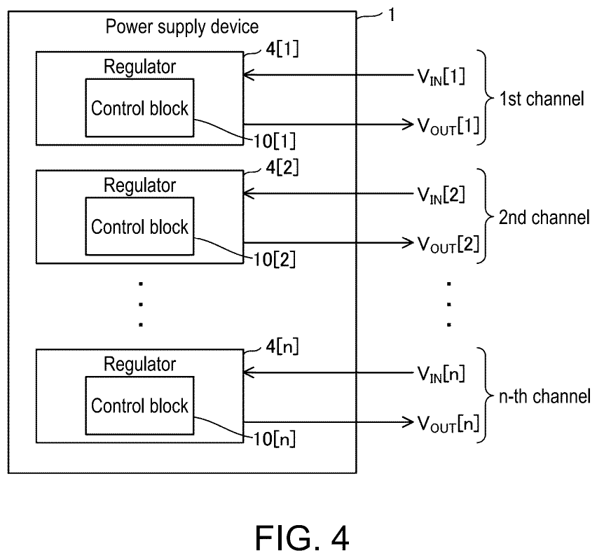

The n control blocks 10 in total in the 1st to n-th channels are provided in the power supply control device 2. In each channel, the regulator 4 is formed by the control block 10 and discrete components connected to the control block 10. As shown in FIG. 4, the regulator 4, the control block 10, the input voltage V_{IN}, and the output voltage V_{OUT} in the i-th channel are specifically denoted as a regulator 4[i], a control block 10[i], an input voltage V_{IN}[i], and an output voltage V_{OUT}[i], respectively. i represents any integer (e.g., any natural number of n or less).

The power supply device 1 performs an operation (power conversion) of generating an output voltage V_{OUT} from an input voltage V_{IN} for each channel. The power supply control device 2 controls the operation (power conversion) of the power supply device 1. That is, the power supply control device 2 controls the operation (power conversion) of the regulator 4 for each channel. Specifically, the operation (power conversion) of the regulator 4 in the i-th channel is controlled by the control block 10[i].

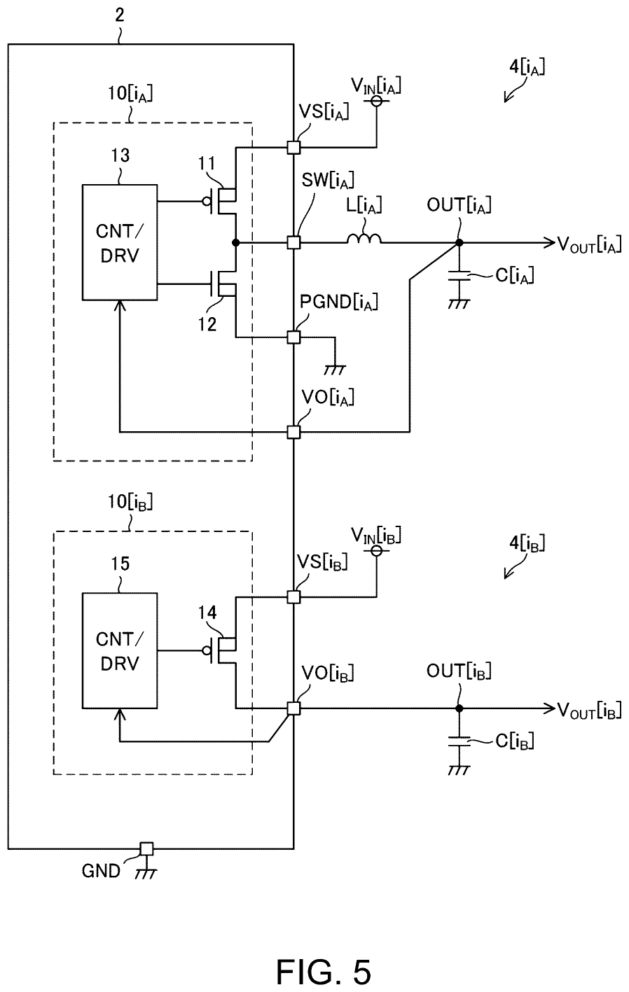

FIG. 5 shows a configuration example of the regulators 4[i_{A}] and 4[i_{B}], which are any two regulators 4 among the regulators 4[1] to 4[n]. The regulator 4[i_{A}] is a step-down switching regulator including a control block 10[i_{A}], an output coil L[i_{A}], and an output capacitor C[i_{A}]. The regulator 4[i_{B}] is a linear regulator including a control block 10[i_{B}] and an output capacitor C[i_{B}]. The regulator 4[i_{B}] may be an LDO (low dropout) regulator. The control blocks 10[i_{A}] and 10[i_{B}] are provided in the power supply control device 2. The output coil L[i_{A}] and the output capacitors C[i_{A}] and C[i_{B}] are constituent elements of the discrete component group 3 (refer to FIG. 1).

Terminals VS[i_{A}], SW[i_{A}], PGND[i_{A}], VO[i_{A}], VS[i_{B}], VO[i_{B}], and GND shown in FIG. 5 are external terminals (seven external terminals in total) provided at the power supply control device 2. The terminal GND is a ground terminal. The ground terminal GND is connected to ground. The terminals VS[i_{A}], SW[i_{A}], PGND[i_{A}], and VO[i_{A}] are an input terminal, a switch terminal, a ground terminal, and a feedback terminal constituting the regulator 4[i_{A}]. The ground terminal PGND[i_{A}] is connected to ground. The ground terminal GND may also be used as the ground terminal PGND[i_{A}]. The terminals VS[i_{B}] and VO[i_{B}] are an input terminal and an output terminal constituting the regulator 4[i_{B}].

The control block 10[i_{A}] includes transistors 11 and 12 and a control drive circuit 13. The transistor 11 is a P-channel MOSFET, and the transistor 12 is an N-channel MOSFET. An input voltage V_{IN}[i_{A}] having a positive DC voltage value is supplied from a voltage source (not shown) provided outside the power supply device 1 to the input terminal VS[i_{A}] through an external wiring. The source of the transistor 11 is connected to the input terminal VS[i_{A}] and receives the input voltage V_{IN}[i_{A}]. The drains of the transistors 11 and 12 are commonly connected to the switch terminal SW[i_{A}], and outside the power supply control device 2, the switch terminal SW[i_{A}] is connected to a first terminal of the output coil L[i_{A}]. A second terminal of the output coil L[i_{A}] is connected to an output node OUT[i_{A}]. The source of the transistor 12 is connected to the ground terminal PGND[i_{A}], and thus is connected to ground. The output capacitor C[i_{A}] is provided between the output node OUT[i_{A}] and ground. That is, a first terminal of the output capacitor C[i_{A}] is connected to the output node OUT[i_{A}], and a second terminal of the output capacitor C[i_{A}] is connected to ground. The voltage at the output node OUT[i_{A}] is an output voltage V_{OUT}[i_{A}].

Feedback information of the output voltage V_{OUT}[i_{A}] is inputted to the control drive circuit 13. In FIG. 5, the feedback terminal VO[i_{A}] is connected to the output node OUT[i_{A}] through an external wiring and is connected to the control drive circuit 13 through an internal wiring (i.e., the output node OUT[i_{A}] is connected to the control drive circuit 13 via the feedback terminal VO[i_{A}]), and thus the output voltage V_{OUT}[i_{A}] itself is inputted to the control drive circuit 13 as feedback information of the output voltage V_{OUT}[i_{A}]. However, the feedback information of the output voltage V_{OUT}[i_{A}] may also be a divided voltage of the output voltage V_{OUT}[i_{A}].

The control drive circuit 13 is connected to the gates of the transistors 11 and 12, and controls the transistors 11 and 12 individually to be on or off by controlling the gate potentials of the transistors 11 and 12. The control drive circuit 13 performs switching drive (switching control) of alternately turning the transistors 11 and 12 on and off based on the feedback information of the output voltage V_{OUT}[i_{A}] such that the output voltage V_{OUT}[i_{A}] is stabilized at a specific target voltage V_{TG}[i_{A}]. By this switching drive, a rectangular wave voltage (a rectangular wave voltage that fluctuates approximately between 0 V and the input voltage V_{IN}[i_{A}]) is generated at the switch terminal SW[i_{A}], which is a connection node between the transistors 11 and 12. The output voltage V_{OUT}[i_{A}] is generated at the output node OUT[i_{A}] as this rectangular wave voltage is rectified and smoothed by the output coil L[i_{A}] and the output capacitor C[i_{A}]. A modification in which the transistor 11 is configured by an N-channel MOSFET may also be adopted, and in that case, a conventional step-up circuit may be added to generate a boosted voltage higher than the input voltage V_{IN}[i], and the on-state of the transistor 11 may be achieved using the boosted voltage.

The control block 10[i_{B}] includes a transistor 14 and a control drive circuit 15. The transistor 14 is a P-channel MOSFET. An input voltage V_{IN}[i_{B}] having a positive DC voltage value is supplied from a voltage source (not shown) provided outside the power supply device 1 to the input terminal VS[i_{B}] through an external wiring. The source of the transistor 14 is connected to the input terminal VS[i_{B}] and receives the input voltage V_{IN}[i_{B}]. The drain of the transistor 14 is connected to the output terminal VO[i_{B}], and the output terminal VO[i_{B}] is connected to an output node OUT[i_{B}] through an external wiring. An output capacitor C[i_{B}] is provided between the output node OUT[i_{B}] and ground. That is, a first terminal of the output capacitor C[i_{B}] is connected to the output node OUT[i_{B}], and a second terminal of the output capacitor C[i_{B}] is connected to ground. The voltage at the output node OUT[i_{B}] (thus, the voltage at the output terminal VO[i_{B}]) is an output voltage V_{OUT}[i_{B}].

Feedback information of the output voltage V_{OUT}[i_{B}] is inputted to the control drive circuit 15. In FIG. 5, with the output terminal VO[i_{B}] connected to the control drive circuit 15, the output voltage V_{OUT}[i_{B}] itself is inputted to the control drive circuit 15 as feedback information of the output voltage V_{OUT}[i_{B}]. However, the feedback information of the output voltage V_{OUT}[i_{B}] may also be a divided voltage of the output voltage V_{OUT}[i_{B}]. The control drive circuit 15 is connected to the gate of the transistor 14. The control drive circuit 15 controls the magnitude of a current supplied to the output node OUT[i_{B}] via the transistor 14 by controlling the gate potential of the transistor 14 based on the feedback information of the output voltage V_{OUT}[i_{B}], and accordingly stabilizes the output voltage V_{OUT}[i_{B}] at a specific target voltage V_{TG}[i_{B}].

Two or more regulators 4 having a configuration equivalent to the regulator 4[i_{A}] may be provided in the power supply device 1. Two or more regulators 4 having a configuration equivalent to the regulator 4[i_{B}] may be provided in the power supply device 1.

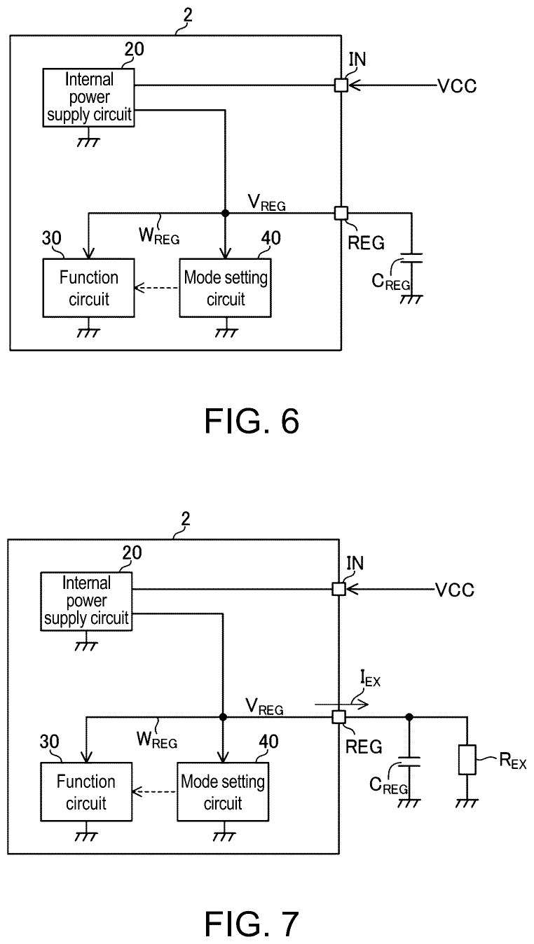

FIG. 6 shows a partial block diagram of the power supply control device 2 viewed from a perspective different from FIG. 5. The power supply control device 2 includes an internal power supply circuit 20, a function circuit 30, and a mode setting circuit 40. The power supply control device 2 includes a group of circuits composed of semiconductors. The group of circuits composed of semiconductors in the power supply control device 2 includes the internal power supply circuit 20, the function circuit 30, and the mode setting circuit 40, and is accommodated within the chassis CS described above. Any other circuits and elements provided in the power supply control device 2, and any internal wiring (including a wiring W_{REG} to be described later) are also accommodated within the chassis CS. The internal power supply circuit 20, the function circuit 30, and the mode setting circuit 40 are each connected to the ground terminal GND (see FIG. 5), and thus connected to ground. A power supply terminal IN and a terminal REG (specific terminal) shown in FIG. 6 are external terminals (two external terminals in total) provided at the power supply control device 2. A capacitor C_{REG} shown in FIG. 6 is a constituent element of the discrete component group 3 (see FIG. 1).

A power supply voltage VCC (input power supply voltage) having a positive DC voltage value is supplied from a voltage source (not shown) provided outside the power supply device 1 to the power supply terminal IN through an external wiring. The internal power supply circuit 20 is connected to the power supply terminal IN and the wiring W_{REG} (internal power supply wiring), generates an internal power supply voltage V_{REG} based on the power supply voltage VCC, and applies the internal power supply voltage V_{REG} to the wiring W_{REG}. The internal power supply circuit 20 operates such that the internal power supply voltage V_{REG} is stabilized at a specific stabilized voltage V_{REG0} (such that a difference between the internal power supply voltage V_{REG} and the stabilized voltage V_{REG0} approaches zero). The stabilized voltage V_{REG0} has a specific positive DC voltage value. The internal power supply circuit 20 may be a series regulator. The wiring W_{REG} is connected to the terminal REG, which is an internal power supply terminal. The capacitor C_{REG} is provided between the terminal REG and ground to keep the internal power supply voltage V_{REG} stable. That is, outside the power supply control device 2, a first terminal of the capacitor C_{REG} is connected to the terminal REG, and a second terminal of the capacitor C_{REG} is connected to ground.

The function circuit 30 is connected to the wiring W_{REG} and operates based on the internal power supply voltage V_{REG}. The function circuit 30 may also operate based on voltages other than the internal power supply voltage V_{REG} in addition to the internal power supply voltage V_{REG}. The function circuit 30 has control blocks 10[1] to 10[n], and thus power conversion is controlled by the function circuit 30 for each channel (power conversion of the regulators 4[1] to 4[n] is controlled).

The mode setting circuit 40 is connected to the wiring W_{REG} and operates based on the internal power supply voltage V_{REG}. The mode setting circuit 40 performs control of switching a content of the operation of the function circuit 30. The content of the operation performed by the function circuit 30 is defined by an operation mode of the function circuit 30. Candidates for the operation mode of the function circuit 30 include first to m-th modes (first to m-th candidate modes). m represents any integer of 2 or more. The mode setting circuit 40 sets one of the first to m-th modes as the operation mode of the function circuit 30, and the function circuit 30 operates in the set operation mode.

As shown in FIG. 7, an external resistor R_{EX} may be provided outside the power supply control device 2, and as shown in FIG. 6, it is also possible that the external resistor R_{EX} is not provided. The case where the external resistor R_{EX} is not provided as shown in FIG. 6 is hereinafter referred to as a reference case. The case where the external resistor R_{EX} is provided as shown in FIG. 7 is hereinafter referred to as a resistor provided case. In the resistor provided case, the external resistor REX becomes a constituent element of the discrete component group 3 (see FIG. 1). In the resistor provided case, a first terminal of the external resistor R_{EX} is connected to the terminal REG, and a second terminal of the external resistor R_{EX} is connected to ground (i.e., the external resistor R_{EX} is connected in parallel to the capacitor C_{REG}).

In the process where the voltage across both terminals of the capacitor C_{REG} rises from 0 V to the stabilized voltage V_{REG0} immediately after the startup of the internal power supply circuit 20, a relatively large charging current is supplied from the internal power supply circuit 20 to the capacitor C_{REG} through the terminal REG. However, in the state (hereinafter referred to as a steady state) after the voltage across both terminals of the capacitor C_{REG} has risen to the stabilized voltage V_{REG0}, the charge and discharge current of the capacitor C_{REG} through the terminal REG is minimal. In the steady state, compared to the reference case, in the resistor provided case, a current flowing from inside to outside of the power supply control device 2 through the wiring W_{REG} and the terminal REG is higher by the current value (V_{REG0}/R_{EX}). The current value (V_{REG0}/R_{EX}) indicates the value of the current flowing to the external resistor R_{EX} when the stabilized voltage V_{REG0} is applied across both terminals of the external resistor R_{EX}. Hereinafter, the current flowing through the terminal REG will be referred to as a terminal current I_{EX}. However, it is assumed that the terminal current I_{EX} flowing from inside to outside of the power supply control device 2 has a positive polarity. That is, it is assumed that the terminal current I_{EX} flowing from the wiring W_{REG}, which is an internal wiring, to outside (the capacitor C_{REG} or the external resistor R_{EX}) of the power supply control device 2 through the terminal REG has a positive polarity.

The mode setting circuit 40 has a function of detecting the terminal current I_{EX} in the steady state, and sets one of the first to m-th modes as the operation mode of the function circuit 30 according to the terminal current I_{EX} in the steady state.

In the case where “m=2”, the mode setting circuit 40 may compare the terminal current I_{EX} in the steady state with a single threshold current I_{TH}, set the j_{A}-th mode as the operation mode of the function circuit 30 if the terminal current I_{EX} in the steady state is less than the single threshold current I_{TH}, and set the j_{B}-th mode as the operation mode of the function circuit 30 if the terminal current I_{EX} in the steady state is equal to or greater than the single threshold current I_{TH}. Herein, (j_{A}, j_{B})=(1, 2), or (j_{A}, j_{B})=(2, 1).

In the case where “m>3”, the mode setting circuit 40 may set one of the first to m-th modes as the operation mode of the function circuit 30 by comparing the terminal current I_{EX} in the steady state with multiple threshold currents. For example, in the case where “m=3”, the mode setting circuit 40 compares the terminal current I_{EX} in the steady state with two threshold currents I_{TH1} and I_{TH2} (herein, “0<I_{TH1}<I_{TH2}” holds). Then, the mode setting circuit 40 may set the j_{A}-th mode as the operation mode of the function circuit 30 if the terminal current I_{EX} in the steady state is less than the threshold current I_{TH1}, set the j_{B}-th mode as the operation mode of the function circuit 30 if the terminal current I_{EX} in the steady state is equal to or greater than the threshold current I_{TH1} and less than the threshold current I_{TH2}, and set the j_{C}-th mode as the operation mode of the function circuit 30 if the terminal current I_{EX} in the steady state is equal to or greater than the threshold current I_{TH2}. Herein, j_{A}, j_{B}, and j_{C} represent natural numbers of 3 or less different from each other. The same also applies to the case where “m≥4”.

In the case where “m=2”, the designer or manufacturer of the power supply device 1 may switch the operation mode of the function circuit 30 between the first and second modes by simply switching whether to provide the external resistor R_{EX}. In the case where “m≥3”, the designer or manufacturer of the power supply device 1 may switch the operation mode of the function circuit 30 among the first to m-th modes by determining whether to provide the external resistor R_{EX} and, in the case of providing the external resistor R_{EX}, determining the value of the external resistor R_{EX}.

In an electronic component classified as a PMIC, it is necessary to confirm various operation contents or setting contents (a sequence of generating output voltages, target values of output voltages, device addresses in communication, etc.) before beginning the generation operation of multiple output voltages. In the case where multiple types of PMICs with operation contents or setting contents different from each other are desired, it is common to respond with a first reference method or a second reference method below. In the first reference method, multiple types of PMICs with operation contents or setting contents different from each other are manufactured and sold. However, in the first reference method, since multiple types of PMICs need to be manufactured as separate products, the burden of manufacturing and inventory management increases. In the second reference method, one or more dedicated external terminals are provided at the PMIC, and the operation contents or setting contents are specified by selectively applying voltages of high level or low level to the dedicated external terminals. However, in the second reference method, the need for dedicated external terminals leads to increased size and cost of the electronic component as a PMIC. In addition, due to the demand for miniaturization in recent years, it may be difficult to provide dedicated external terminals in the first place.

In contrast, in the power supply control device 2 according to the present embodiment, the terminal REG for the internal power supply voltage V_{REG}, which is originally necessary for the operation of the internal circuit (function circuit 30), is utilized to perform setting of the operation mode (mode switching). Thus, compared to the first reference method, the burden of manufacturing and inventory management can be reduced, and compared to the second reference method, a reduction in the component size and cost can be expected.

Hereinafter, several specific configuration examples, operation examples, application techniques, modification techniques, etc. related to the power supply device 1 will be described among multiple examples. The matters described above in the present embodiment apply to each of the following examples unless specifically stated otherwise and without contradiction. In each example, in the case where there are matters that contradict the above description, the description in each example may prevail. In addition, as long as there is no contradiction, matters described in any example among the multiple examples shown below may be applied to any other example (i.e., it is also possible to combine any two or more examples among the multiple examples).

### First Example

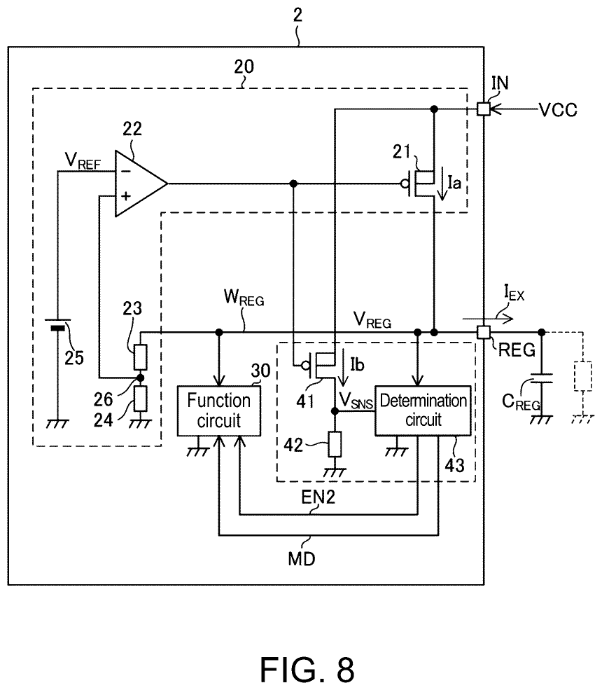

A first example will be described. FIG. 8 shows a partial configuration diagram of the power supply control device 2, including internal configuration examples of the internal power supply circuit 20 and the mode setting circuit 40. The internal power supply circuit 20 includes an output transistor 21, an operational amplifier 22, voltage dividing resistors 23 and 24, and a reference voltage source 25. The mode setting circuit 40 includes a sense transistor 41, a sense resistor 42, and a determination circuit 43. The output transistor 21 and the sense transistor 41 are P-channel MOSFETs.

The sources of the output transistor 21 and the sense transistor 41 are commonly connected to the power supply terminal IN. The gates of the output transistor 21 and the sense transistor 41 are connected to each other. The drain of the output transistor 21 is connected to the wiring W_{REG} (thus connected to the terminal REG). The drain of the sense transistor 41 is connected to ground via the sense resistor 42. That is, the drain of the sense transistor 41 is connected to a first terminal of the sense resistor 42, and a second terminal of the sense resistor 42 is connected to ground.

A first terminal of the voltage dividing resistor 23 is connected to the wiring WREG (thus connected to the terminal REG). A second terminal of the voltage dividing resistor 23 is connected to a first terminal of the voltage dividing resistor 24 at a node 26. A second terminal of the voltage dividing resistor 24 is connected to ground. The reference voltage source 25 generates a specific reference voltage V_{REF} based on the power supply voltage VCC. The reference voltage V_{REF} has a positive DC voltage value lower than the power supply voltage VCC. A non-inverting input terminal of the operational amplifier 22 is connected to the node 26. The reference voltage V_{REF} is supplied from the reference voltage source 25 to an inverting input terminal of the operational amplifier 22. An output terminal of the operational amplifier 22 is connected to the gates of the output transistor 21 and the sense transistor 41. The operational amplifier 22 operates based on the power supply voltage VCC with reference to the ground potential.

The drain current of the output transistor 21 is referred to as a current Ia. The current Ia corresponds to the output current of the output transistor 21. The terminal current I_{EX} flows through the output transistor 21 and the terminal REG. At this time, a part of the current Ia becomes the terminal current I_{EX}. The drain current of the sense transistor 41 is referred to as a current Ib. A current mirror circuit is formed by the output transistor 21 and the sense transistor 41. Thus, the current Ib is proportional to the current Ia. Accordingly, using a proportionality coefficient k between the currents Ia and Ib, the current Ib is expressed as “Ib=k×Ia”. The mode setting circuit 40 uses the current Ib as a reference current for estimating the current Ia and the terminal current I_{EX}. However, the size of the sense transistor 41 is much smaller compared to the size of the output transistor 21, so k has a positive value (e.g., 1/several hundred) sufficiently smaller than 1. The voltage at the drain of the sense transistor 41 is referred to as a sense voltage V_{SNS}. The sense voltage V_{SNS} is a voltage drop generated at the sense resistor 42 as the current Ib flows to the sense resistor 42, and has a voltage value proportional to the current Ib.

The determination circuit 43 is connected to the drain of the sense transistor 41 and receives the sense voltage V_{SNS}. The input impedance of the determination circuit 43 as viewed from the drain of the sense transistor 41 is sufficiently large, and the current between the drain of the sense transistor 41 and the determination circuit 43 may be considered zero. In addition, the determination circuit 43 is connected to the wiring W_{REG} and receives the internal power supply voltage V_{REG}. The determination circuit 43 operates based on the internal power supply voltage V_{REG} with reference to the ground potential. Before the function circuit 30 starts up, the determination circuit 43 decides the operation mode of the function circuit 30 based on the sense voltage V_{SNS} corresponding to the terminal current I_{EX} in the steady state. The determination circuit 43 outputs a mode determination signal MD indicating a decision content of the determination circuit 43 to the function circuit 30, and outputs a signal EN2 of active level to the function circuit 30 simultaneously with or immediately after the output of the mode determination signal MD to start up the function circuit 30. The signal EN2 corresponds to an enable signal for the function circuit 30. Upon receiving the signal EN2 of active level, the function circuit 30 starts up and begins operation in the operation mode according to the content specified by the mode determination signal MD.

The mode setting circuit 40 refers to the proportional current Ib of the current Ia serving as the source of the terminal current I_{EX}, to detect the presence or absence of the external resistor R_{EX} based on the magnitude of the terminal current I_{EX} after the internal power supply voltage V_{REG} has reached the stabilized voltage V_{REG0}. To suppress unnecessary power consumption due to the provision of the external resistor R_{EX}, it is not preferable to configure the value of the external resistor R_{EX} to be too small even in the resistor provided case (see FIG. 7). On the other hand, the consumption current of the function circuit 30 during operation of the function circuit 30 is supplied through the output transistor 21 (although it may be supplied from the capacitor C_{REG} transiently), and this consumption current is relatively large. Thus, after the function circuit 30 has started up, the proportion of the consumption current of the function circuit 30 in the current Ia becomes considerably large, and it is difficult to distinguish the presence or absence of the external resistor R_{EX} from the current Ib. In addition, the operation mode of the function circuit 30 should be confirmed before the function circuit 30 starts up. For this reason, the determination circuit 43 decides the operation mode of the function circuit 30 based on the sense voltage V_{SNS} before the startup of the function circuit 30.

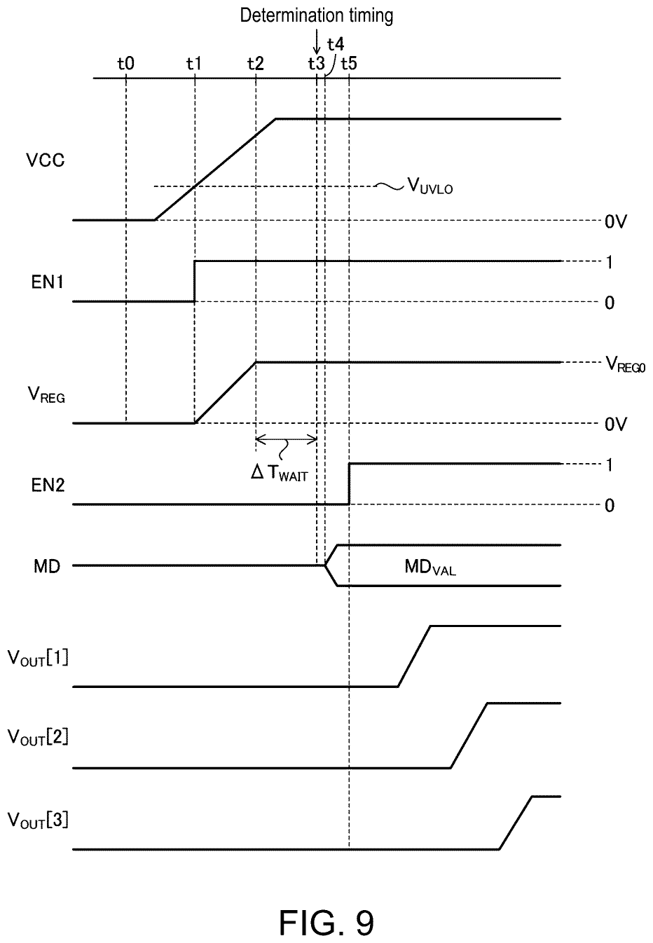

FIG. 9 shows a timing chart around the startup time of the power supply control device 2. As time progresses, time points t0, t1, t2, t3, t4, and t5 arrive sequentially. In the steady state, the power supply voltage VCC having a positive DC voltage value is supplied to the power supply terminal IN, but in the example of FIG. 9, until immediately before the time point t3, the supply voltage to the power supply terminal IN is either 0 V or in the process of rising. At the time point t0, the supply voltage to the power supply terminal IN is assumed to be 0 V. Thus, at the time point t0, the internal power supply circuit 20 is stopped, and the internal power supply voltage V_{REG} is 0 V (zero volts). After the time point t0, toward an intermediate time point between the time points t2 and t3, the power supply voltage VCC supplied to the power supply terminal IN rises from 0 V to a sufficiently high positive DC voltage, after which the power supply voltage VCC supplied to the power supply terminal IN becomes constant.

The power supply control device 2 is provided with a low voltage detection circuit (not shown) that detects a high-low relationship between the power supply voltage VCC and a specific low voltage detection voltage V_{UVLO} (V_{UVLO}>0). The low voltage detection circuit generates and outputs an internal signal EN1 having a value of “0” or “1”. When the power supply voltage VCC is sufficiently low, the internal signal EN1 has a value of “0”. The low voltage detection circuit changes the value of the internal signal EN1 from “0” to “1” in response to a change from “VCC<V_{UVLO}” to “VCC≥V_{UVLO}”. The internal power supply circuit 20 is configured to stop when the internal signal EN1 has a value of “0”, and to start up in response to a change of the value of the internal signal EN1 from “0” to “1”. In the example of FIG. 9, the time point t1 corresponds to the timing of the change in the value of the internal signal EN1 from “0” to “1”, and thus at the time point t1, the internal power supply circuit 20 starts up (the internal power supply circuit 20 begins operation), and begins to raise the internal power supply voltage V_{REG} from 0 V. When “VCC>V_{UVLO}”, the internal power supply circuit 20 may operate normally.

The operational amplifier 22 controls the current Ia (output current of the output transistor 21) by controlling the gate voltage of the output transistor 21 to reduce the potential difference between the non-inverting input terminal and the inverting input terminal of the operational amplifier 22. Specifically, the operational amplifier 22 controls the gate voltage of the output transistor 21 such that, when the voltage at the non-inverting input terminal of the operational amplifier 22 is higher than the voltage at the inverting input terminal of the operational amplifier 22, the gate voltage of the output transistor 21 rises, and when the voltage at the non-inverting input terminal of the operational amplifier 22 is lower than the voltage at the inverting input terminal of the operational amplifier 22, the gate voltage of the output transistor 21 decreases. Immediately after the time point t1, when the internal power supply voltage V_{REG} is substantially around 0 V, the voltage at the node 26 is also around 0 V and lower than the reference voltage V_{REF}, and thus the operational amplifier 22 decreases the gate voltage of the output transistor 21. As a result, from immediately after the time point t1, the current Ia is generated, and the internal power supply voltage V_{REG} rises as the capacitor C_{REG} is charged. The rise in the internal power supply voltage V_{REG} continues until the time point t2, and at the time point t2, the internal power supply voltage V_{REG} reaches the stabilized voltage V_{REG0} described above. When “V_{REG}=V_{REG0}”, the voltage at the node 26 is equal to the reference voltage V_{REF}.

In this manner, the operational amplifier 22 controls the current Ia (output current of the output transistor 21) such that the internal power supply voltage V_{REG} is stabilized at a specific voltage (stabilized voltage V_{REG0}) corresponding to the resistance ratio of the voltage dividing resistors 23 and 24 and the reference voltage V_{REF}. In the example of FIG. 9, the rise in the power supply voltage VCC stops after the time point t2 and before reaching the time point t3, but the time point at which the rise in the power supply voltage VCC stops may be any time point after the time point t1.

The state at the time point t2 and thereafter is the state after the voltage across both terminals of the capacitor C_{REG} has risen to the stabilized voltage V_{REG0}, i.e., the steady state (internal power supply steady state) described above. The determination circuit 43 starts up after the internal power supply circuit 20 starts up and after the internal power supply voltage V_{REG} has increased to higher than 0 V, and may operate stably after the internal power supply voltage V_{REG} has reached the stabilized voltage V_{REG0}. The determination circuit 43 sets the time point t3, which is after the time point t2, as a determination timing. The time point t3 is a time point that is later than the time point t2 by a waiting time ΔT_{WAIT}.

The waiting time ΔT_{WAIT} does not need to be measured strictly, and it is sufficient for the determination circuit 43 to set the determination timing (time point t3) to a timing at which the internal power supply voltage V_{REG} is sufficiently expected to have reached the stabilized voltage V_{REG0}. In a design stage of the power supply control device 2, the time difference between the time points t1 and t2 is recognized through calculation or experiments. Although the time difference between the time points t1 and t2 varies under various conditions, after the startup of the determination circuit 43, the determination circuit 43 may set the determination timing (time point t3) to a timing at which the internal power supply voltage V_{REG} is sufficiently expected to have reached the stabilized voltage V_{REG0}, while considering a maximum value that the time difference between the time points t1 and t2 may take. In addition, a measurement circuit may be provided in the determination circuit 43 to determine whether an elapsed time since the internal power supply voltage V_{REG} reached the stabilized voltage V_{REG0} has reached the waiting time ΔT_{WAIT}, and in that case, the determination circuit 43 may decide the determination timing using the measurement circuit. The measurement circuit may be formed with a conventional analog circuit or digital circuit for measuring time. The measurement circuit may operate based on the power supply voltage VCC or the internal power supply voltage V_{REG}. Hereinafter, the sense voltage V_{SNS} at the determination timing (time point t3) will be specifically denoted as a sense voltage V_{SNS}[t3].

At the determination timing (time point t3), the function circuit 30 has not yet started up. Thus, the current Ia at the determination timing becomes a sum of the current flowing to the voltage dividing resistors 23 and 24, the consumption current of the determination circuit 43, and the terminal current I_{EX}. Under “V_{REG}=V_{REG0}”, the current flowing to the voltage dividing resistors 23 and 24 is constant, and the consumption current of the determination circuit 43 may also be considered approximately constant. Thus, the current Ia at the determination timing in the resistor provided case becomes larger by the current value (V_{REG0}/R_{EX}) than the current Ia at the determination timing in the reference case. As a result, the sense voltage V_{SNS}[t3] in the resistor provided case becomes higher by a voltage corresponding to the current value (V_{REG0}/R_{EX}) than the sense voltage V_{SNS}[t3] in the reference case.

The determination circuit 43 compares the sense voltage V_{SNS}[t3] with the threshold voltages V_{TH}[1] to V_{TH}[m−1], and determines which of the first to m-th modes to set as the operation mode of the function circuit 30 based on the high-low relationship between the sense voltage V_{SNS}[t3] and the threshold voltages V_{TH}[1] to V_{TH}[m−1]. If “m=2”, the threshold voltage compared with the sense voltage V_{SNS}[t3] is the threshold voltage V_{TH}[1] only. If “m≥3”, the total number of threshold voltages compared with the sense voltage V_{SNS}[t3] becomes 2 or more. “V_{TH}[1]>0”, and “V_{TH}[j]<V_{TH}[j+1]” holds for any integer j.

The determination circuit 43 generates a mode determination signal MD indicating the result of the above determination. The mode determination signal MD is a digital signal, and the value included in the mode determination signal MD is referred to as a mode determination value MD_{VAL}.

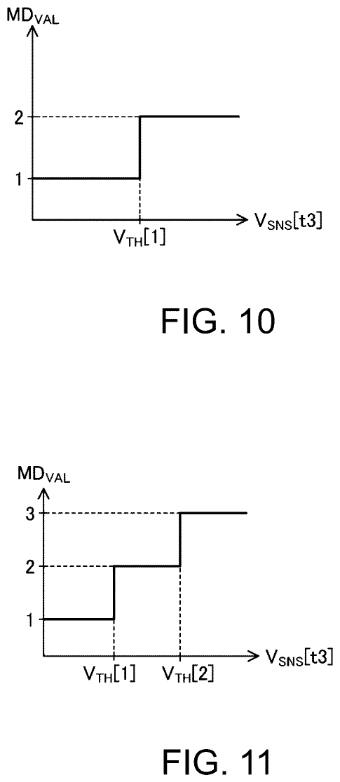

When “m=2”, the mode determination value MD_{VAL} has either “1” or “2” (refer to FIG. 10). In the case where “m=2”, the determination circuit 43 sets the mode determination value MD_{VAL} to “1” when “V_{SNS}[3]<V_{TH}[1]” holds, and sets the mode determination value MD_{VAL} to “2” when “V_{TH}[1]≤V_{SNS}[t3]” holds.

When “m=3”, the mode determination value MD_{VAL} has one of “1”, “2”, and “3” (refer to FIG. 11). In the case where “m=3”, the determination circuit 43 sets the mode determination value MD_{VAL} to “1” when “V_{SNS}[13]<V_{TH}[1]” holds, sets the mode determination value MD_{VAL} to “2” when “V_{TH}[1]≤V_{SNS}[13]<V_{TH}[2]” holds, and sets the mode determination value MD_{VAL} to “3” when “V_{TH}[2]≤V_{SNS}[t3]” holds. Similarly, in the case of “m=4”, an integer of 1 or more and m or less is set for the mode determination value MD_{VAL} according to the high-low relationship between the sense voltage V_{SNS}[t3] and the threshold voltages V_{TH}[1] to V_{TH}[m−1].

The mode determination signal MD is a signal that specifies which of the first to m-th modes to set the operation mode of the function circuit 30. At the time point t4, the determination circuit 43 outputs the mode determination signal MD having the mode determination value MD_{VAL} corresponding to the high-low relationship between the sense voltage V_{SNS}[t3] and the threshold voltages V_{TH}[1] to V_{TH}[m−1] to the function circuit 30. The time point t4 is a time point that has elapsed a slight time from the time point t3, and may be considered to substantially coincide with the time point t3. The mode determination signal MD before the time point t4 does not have a significant value. Furthermore, at the time point t5, which has elapsed a slight time from the time point t4, the determination circuit 43 changes the value of the signal EN2 that the determination circuit 43 supplies to the function circuit 30 from “0” to “1”. The determination circuit 43 maintains the value of the signal EN2 at “0” until immediately before the time point t5.

The signal EN2 of “0” has a non-active level, and when the signal EN2 has a value of “0”, the function circuit 30 is in a stopped state (the function circuit 30 stops its own operation). The signal EN2 of “1” has an active level, and in response to a change in the value of the signal EN2 from “0” to “1”, the function circuit 30 starts up (begins operation of the function circuit 30), and thereafter, as long as the value of the signal EN2 has “1”, the function circuit 30 continues operation. Thus, before the time point t5, power conversion is not executed in any of the control blocks 10[1] to 10[n] (refer to FIG. 4), and all output voltages V_{OUT}[1] to V_{OUT}[n] are 0 V. After the time point t5, the control blocks 10[1] to 10[n] begin power conversion according to a defined sequence, and all or a part of the output voltages V_{OUT}[1] to V_{OUT}[n] rise from 0 V. In the example of FIG. 9, it is shown that each output voltage V_{OUT} rises in the sequence of the output voltages V_{OUT}[1], V_{OUT}[2], and V_{OUT}[3].

The operation mode of the function circuit 30 is determined according to the mode determination signal MD. In the case where “m=2”, if “MD_{VAL}=1”, the operation mode of the function circuit 30 is set to the first mode, and if “MD_{VAL}=2”, the operation mode of the function circuit 30 is set to the second mode. Alternatively, in the case where “m=2”, if “MD_{VAL}=1”, the operation mode of the function circuit 30 is set to the second mode, and if “MD_{VAL}=2”, the operation mode of the function circuit 30 is set to the first mode.

In the case where “m=3”, if “MD_{VAL}=1”, “MD_{VAL}=2”, and “MD_{VAL}=3”, the operation mode of the function circuit 30 is set to the first, second, and third modes, respectively. Alternatively, in the case where “m=3”, if “MD_{VAL}=1”, “MD_{VAL}=2”, and “MD_{VAL}=3”, the operation mode of the function circuit 30 is set to the first, third, and second modes, respectively, or set to the second, first, and third modes, respectively, or set to the second, third, and first modes, respectively, or set to the third, first, and second modes, respectively, or set to the third, second, and first modes, respectively. The same also applies to the case where “m≥4”, and as long as the operation modes set according to different mode determination values MD_{VAL} are different from each other, the method for setting the operation mode may be any method. In any case, the function circuit 30 starts up in the operation mode corresponding to the mode determination signal MD.

In the case where “m=2”, the mode setting circuit 40 may be said to have a function of determining whether an external resistor R_{EX} is connected between the terminal REG and ground according to the terminal current I_{EX}, and set the operation mode of the function circuit 30 based on the determination result. Specifically, the mode setting circuit 40 generates the sense voltage V_{SNS}[t3] by performing voltage conversion on the current Ib corresponding to the terminal current I_{EX} at the determination timing, and sets the operation mode of the function circuit 30 to the first mode or the second mode by binarizing the sense voltage V_{SNS}[t3].

In the case where “m≥3”, the mode setting circuit 40 may be said to set the operation mode of the function circuit 30 according to the terminal current I_{EX}, which depends on the magnitude of a resistance component between the terminal REG and ground outside the power supply control device 2. In the reference case (FIG. 6), the magnitude of the above resistance component may be considered infinite if the leakage current of the capacitor C_{REG} is ignored (or may also be considered as a magnitude of the resistance component of the capacitor C_{REG}). In the resistor provided case (FIG. 7), the magnitude of the above resistance component is the value of the external resistor R_{EX}, and in the resistor provided case, the terminal current I_{EX} changes depending on the value of the external resistor R_{EX}.

### Second Example

A second example will be described. The second example is a modification of a part of the first example, and for matters not specifically described in the second example, the description of the first example is also applicable to the second example.

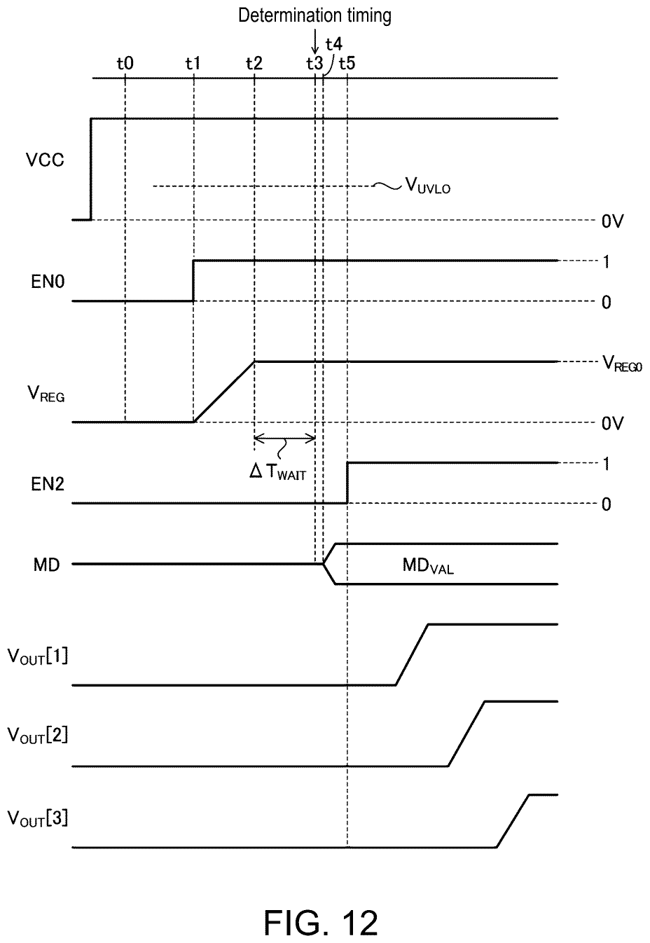

Although the change in the value of the internal signal EN1 from “0” to “1” has been described as an example of the startup condition of the internal power supply circuit 20, the startup condition of the internal power supply circuit 20 is not limited thereto. For example, as shown in FIG. 12, the startup condition of the internal power supply circuit 20 may also be a change in the value of an enable signal EN0 from “0” to “1”.

FIG. 12 is a timing chart around the startup time of the power supply control device 2 according to the second example. In the example of FIG. 12, a sufficiently high power supply voltage VCC has been continuously supplied to the power supply terminal IN from before the time point t0. The power supply control device 2 is provided with an enable terminal (not shown) as one of the external terminals, and an enable signal EN0 is supplied to this enable terminal from an external circuit of the power supply control device 2. The enable signal EN0 is a binary signal having a value of “0” or “1”. Herein, a high-level enable signal EN0 (e.g., an enable signal EN0 having the level of the power supply voltage VCC) has a value of “1”, and a low-level enable signal EN0 (e.g., an enable signal EN0 having the level of ground) has a value of “0”.

Until immediately before the time point t1, the enable signal EN0 has a value of “0”. In the second example, at the time point t1, the value of the enable signal EN0 changes from “0” to “1”. The internal power supply circuit 20 according to the second example stops when the enable signal EN0 has a value of “0”, and starts up in response to a change in the value of the enable signal EN0 from “0” to “1”. Thus, at the time point t1, the internal power supply circuit 20 starts up (the internal power supply circuit 20 begins operation), and begins to increase the internal power supply voltage V_{REG} from 0 V. The operation after the time point t1 is as described in the first example.

Although different from the situation shown in FIG. 12, the power supply voltage VCC itself may also be inputted to the above enable terminal. In that case, the time point at which the voltage (VCC) supplied to the power supply terminal IN and the enable terminal rises from 0 V to a specific positive DC voltage corresponds to the time point t1.

### Third Example

A third example will be described. In the third example, several examples of internal circuits of the determination circuit 43 will be presented.

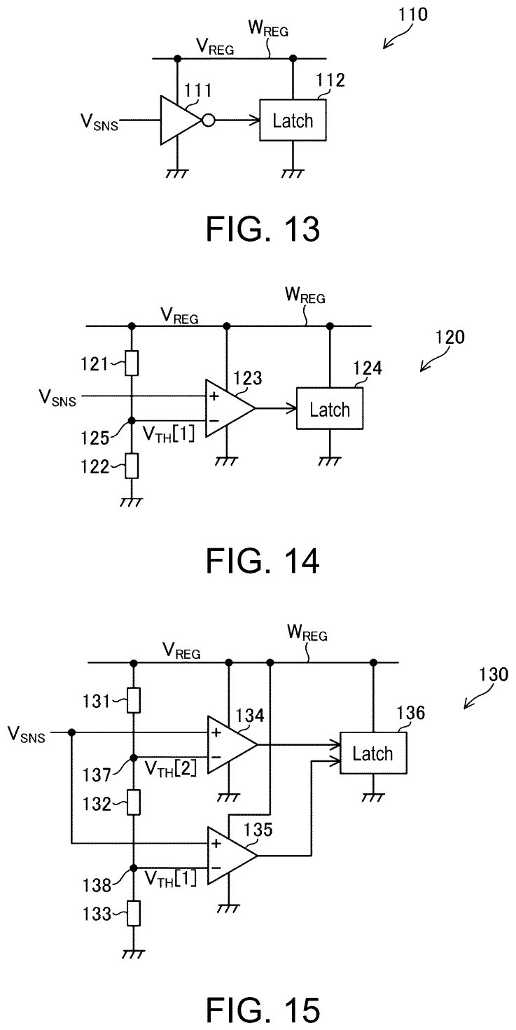

In the case where “m=2”, a detection circuit 110 shown in FIG. 13 may be provided in the determination circuit 43. The detection circuit 110 includes an inverter circuit 111 and a latch circuit 112. The inverter circuit 111 and the latch circuit 112 are driven based on the internal power supply voltage V_{REG}. The sense voltage V_{SNS} is supplied to an input terminal of the inverter circuit 111. The inverter circuit 111 outputs a low-level signal when the sense voltage V_{SNS} is equal to or higher than a threshold voltage in the inverter circuit 111, and outputs a high-level signal when the sense voltage V_{SNS} is lower than the threshold voltage in the inverter circuit 111. The threshold voltage in the inverter circuit 111 has a positive voltage value lower than the internal power supply voltage V_{REG}, and is approximately ½ of the internal power supply voltage V_{REG}. In the configuration of FIG. 13, the threshold voltage in the inverter circuit 111 corresponds to the threshold voltage V_{TH}[1] described above.

The latch circuit 112 latches (holds) the level of the output signal of the inverter circuit 111 at the determination timing. The determination circuit 43 having the detection circuit 110 may generate and output the mode determination signal MD based on the level latched by the latch circuit 112 (i.e., based on the output signal of the inverter circuit 111 at the determination timing).

Alternatively, in the case where “m=2”, a detection circuit 120 shown in FIG. 14 may be provided in the determination circuit 43. The detection circuit 120 includes a resistor 121, a resistor 122, a comparator 123, and a latch circuit 124. The comparator 123 and the latch circuit 124 are driven based on the internal power supply voltage V_{REG}. A first terminal of the resistor 121 is connected to the wiring W_{REG}, a second terminal of the resistor 121 is connected to a first terminal of the resistor 122 at a node 125, and a second terminal of the resistor 122 is connected to ground. The sense voltage V_{SNS} is supplied to a non-inverting input terminal of the comparator 123, and an inverting input terminal of the comparator 123 is connected to the node 125. In the detection circuit 120 of FIG. 14, the voltage at the node 125 corresponds to the threshold voltage V_{TH}[1] described above. The comparator 123 compares the sense voltage V_{SNS} with the voltage V_{TH}[1] at the node 125, and outputs a signal indicating a high-low relationship between the sense voltage V_{SNS} and the voltage V_{TH}[1] at the node 125. The comparator 123 outputs a high-level signal when “V_{TH}[1]≤V_{SNS}” holds, and outputs a low-level signal when “V_{TH}[1]>V_{SNS}” holds.

The latch circuit 124 latches (holds) the level of the output signal of the comparator 123 at the determination timing. The determination circuit 43 having the detection circuit 120 may generate and output the mode determination signal MD based on the level latched by the latch circuit 124 (i.e., based on the output signal of the comparator 123 at the determination timing).

In the case where “m=3”, the detection circuit 130 shown in FIG. 15 may be provided in the determination circuit 43. The detection circuit 130 includes resistors 131 to 133, comparators 134 and 135, and a latch circuit 136. The comparators 134 and 135 and the latch circuit 136 are driven based on the internal power supply voltage V_{REG}. A first terminal of the resistor 131 is connected to the wiring W_{REG}, a second terminal of the resistor 131 is connected to a first terminal of the resistor 132 at a node 137, a second terminal of the resistor 132 is connected to a first terminal of the resistor 133 at a node 138, and a second terminal of the resistor 133 is connected to ground. The sense voltage V_{SNS} is supplied to each non-inverting input terminal of the comparators 134 and 135. An inverting input terminal of the comparator 134 is connected to the node 137, and an inverting input terminal of the comparator 135 is connected to the node 138. In the detection circuit 130 of FIG. 15, the voltage at the node 137 corresponds to the threshold voltage V_{TH}[2] described above, and the voltage at the node 138 corresponds to the threshold voltage V_{TH}[1] described above. The comparator 134 compares the sense voltage V_{SNS} with the voltage V_{TH}[2] at the node 137, and outputs a signal indicating a high-low relationship between the sense voltage V_{SNS} and the voltage V_{TH}[2] at the node 137. The comparator 134 outputs a high-level signal when “V_{TH}[2]≤V_{SNS}” holds, and outputs a low-level signal when “V_{TH}[2]>V_{SNS}” holds. The comparator 135 compares the sense voltage V_{SNS} with the voltage V_{TH}[1] at the node 138, and outputs a signal indicating a high-low relationship between the sense voltage V_{SNS} and the voltage V_{TH}[1] at the node 138. The comparator 135 outputs a high-level signal when “V_{TH}[1]≤V_{SNS}” holds, and outputs a low-level signal when “V_{TH}[1]>V_{SNS}” holds.

The latch circuit 136 latches (holds) the level of each output signal of the comparators 134 and 135 at the determination timing. The determination circuit 43 having the detection circuit 130 may generate and output the mode determination signal MD based on the levels latched by the latch circuit 136 (i.e., based on each output signal of the comparators 134 and 135 at the determination timing).

In the case where “m≥4”, a necessary number of comparators may be prepared to determine the high-low relationship between the sense voltage and the threshold voltages V_{TH}[1] to V_{TH}[m−1] at the determination timing.

### Fourth Example

A fourth example will be described. Examples of methods for causing the operation of the function circuit 30 to differ based on differences in the operation mode include methods MTD1 to MTD4 below.

The function circuit 30 according to the method MTD1 causes the output voltage V_{OUT} of the regulator 4 of a specific channel to differ between when the operation mode is the x-th mode and when the operation mode is the y-th mode. x and y represent natural numbers of m or less different from each other, e.g., (x, y)=(1, 2) or (x, y)=(2, 1). That is, for example, the function circuit 30 according to the method MTD1 causes the output voltage V_{OUT}[i] of the regulator 4[i] to differ between when the operation mode is the x-th mode and when the operation mode is the y-th mode. Since the output voltage V_{OUT}[i] is stabilized at the target voltage V_{TG}[i], specifically, the function circuit 30 according to the method MTD1 causes the target voltage V_{TG}[i] of the output voltage V_{OUT}[i] of the regulator 4[i] to differ between when the operation mode is the x-th mode and when the operation mode is the y-th mode.

For example, when the operation mode of the function circuit 30 is the x-th mode, the regulator 4[i] operates such that the output voltage V_{OUT}[i] is stabilized at a target voltage V_{TG}[i] of 1.8 V, and when the operation mode of the function circuit 30 is the y-th mode, the regulator 4[i] operates such that the output voltage V_{OUT}[i] is stabilized at a target voltage V_{TG}[i] of 2.5 V.

According to the method MTD1, a designer of the system including the power supply control device 2 may generate a desired voltage from a specific channel.

The function circuit 30 according to the method MTD2 causes a generation sequence of the output voltages V_{OUT}[1] to V_{OUT}[n] to differ between when the operation mode is the x-th mode and when the operation mode is the y-th mode. After the function circuit 30 starts up, by sequentially operating the control blocks 10[1] to 10[n] in a defined sequence, the function circuit 30 sequentially generates the output voltages V_{OUT}[1] to V_{OUT}[n] in a defined sequence. The function circuit 30 according to the method MTD2 switches this generation sequence according to the operation mode.

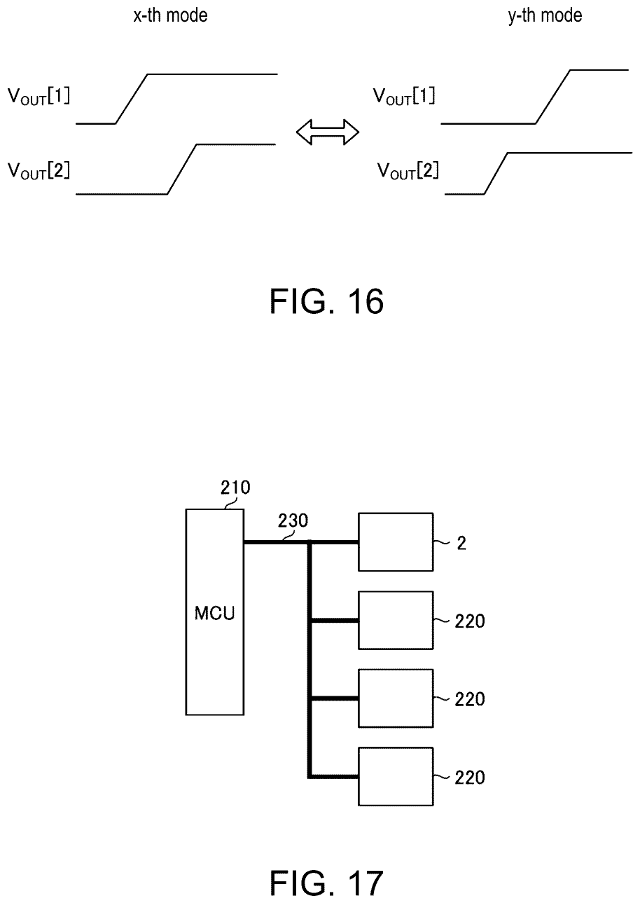

Referring to FIG. 16, a specific example of the method MTD2 will be presented. Focusing only on the 1st and 2nd channels, when the operation mode of the function circuit 30 is set to the x-th mode, of the control blocks 10[1] and 10[2], the function circuit 30 first begins power conversion only in the control block 10[1], and, after the output voltage V_{OUT}[1] reaches or is around the target voltage V_{TG}[1], begins power conversion in the control block 10[2] to raise the output voltage V_{OUT}[2] from 0 V toward the target voltage V_{TG}[2]. In contrast, when the operation mode of the function circuit 30 is set to the y-th mode, of the control blocks 10[1] and 10[2], the function circuit 30 first begins power conversion only in the control block 10[2], and, after the output voltage V_{OUT}[2] reaches or is around the target voltage V_{TG}[2], begins power conversion in the control block 10[1] to raise the output voltage V_{OUT}[1] from 0 V toward the target voltage V_{TG}[1].

According to the method MTD2, a designer of the system including the power supply control device 2 may generate each output voltage V_{OUT} in a desired sequence.

The function circuit 30 according to the method MTD3 executes power conversion (generation operation of output voltage V_{OUT}) by the regulator 4 of a specific channel when the operation mode is the x-th mode, and stops power conversion (generation operation of output voltage V_{OUT}) by the regulator 4 of the specific channel when the operation mode is the y-th mode.

For example, when the operation mode of the function circuit 30 is the x-th mode, power conversion by the regulator 4[i] is executed and the output voltage V_{OUT}[i] is generated (the output voltage V_{OUT}[i] of “V_{OUT}[i]=V_{TG}[i]” is obtained). When the operation mode of the function circuit 30 is the y-th mode, power conversion by the regulator 4[i] is not executed and the output voltage V_{OUT}[i] is maintained at 0 V.

According to the method MTD3, it is possible to stop the generation operation of an unnecessary output voltage V_{OUT}. Although the power supply control device 2 can be used to generate output voltages V_{OUT} for n channels, depending on the system, output voltages V_{OUT} may be needed for only (n−1) channels. By using the method MTD3, a common power supply control device 2 can be applied to both a system that requires output voltages V_{OUT} for n channels and a system that requires output voltages V_{OUT} for (n−1) channels.

The function circuit 30 according to the method MTD4 causes an address assigned to the power supply control device 2 in the communication between the power supply control device 2 and other devices to differ between when the operation mode is the x-th mode and when the operation mode is the y-th mode.

The method MTD4 will be described in detail with reference to FIG. 17. The system related to the method MTD4 includes a power supply control device 2, an MCU (micro controller unit) 210, and one or more devices 220 (three devices 220 in FIG. 17). The MCU 210, the power supply control device 2, and each device 220 are connected to each other via a communication bus 230. Bidirectional communication is possible between the MCU 210 and the power supply control device 2 via the communication bus 230. Bidirectional communication is possible between the MCU 210 and each device 220 via the communication bus 230. The communication of the MCU 210 with the power supply control device 2 and each device 220 is serial communication, and an interface based on I²C (inter-integrated circuit) is used as the interface for serial communication.

In the communication in the system of FIG. 17, the MCU 210 functions as a master device, and the power supply control device 2 and each device 220 function as slave devices. Herein, the total number of devices 220 is assumed to be three. Thus, there are four slave devices in total in the system of FIG. 17. At this time, the MCU 210 as the master device may communicate with only one slave device among the four slave devices at any timing, for example. The MCU 210 associates unique addresses with the four slave devices. The four slave devices are called first to fourth slave devices, and in the system of FIG. 17, first to fourth addresses are assigned to the first to fourth slave devices, respectively. When the MCU 210 performs communication with the first slave device, the MCU 210 outputs a first command signal including an address signal indicating the first address to the communication bus 230. The first command signal is received by each slave device, but among the first to fourth slave devices, only the first slave device to which the first address is assigned responds to the first command signal and performs an operation according to the first command signal. Similarly, when the MCU 210 performs communication with the second slave device, the MCU 210 outputs a second command signal including an address signal indicating the second address to the communication bus 230. The second command signal is received by each slave device, but among the first to fourth slave devices, only the second slave device to which the second address is assigned responds to the second command signal and performs an operation according to the second command signal. The same also applies when performing communication with the third or fourth slave device.

The function circuit 30 according to the method MTD4 decides the address to be assigned to the power supply control device 2 in the communication between the power supply control device 2 and the MCU 210 according to the operation mode. For example, the function circuit 30 according to the method MTD4 performs communication recognizing that the address assigned to the power supply control device 2 is the first address in the case where the first mode is set as the operation mode, and performs communication recognizing that the address assigned to the power supply control device 2 is the second address in the case where the second mode is set as the operation mode. Thus, in the case where the first mode is set as the operation mode, the function circuit 30 executes an operation in response to the first command signal, but does not respond to the second command signal (does not execute an operation in response to the second command signal). In the case where the second mode is set as the operation mode, the function circuit 30 executes an operation in response to the second command signal, but does not respond to the first command signal (does not execute an operation in response to the first command signal). The function circuit 30 according to the method MTD4 may also recognize that the address assigned to the power supply control device 2 is the third or fourth address according to the operation mode.

By using the method MTD4, it is possible to decrease external terminals for address setting or reduce the number of necessary external terminals for address setting. The one or more devices 220 may be power supply control devices having a configuration equivalent to the power supply control device 2. That is, for example, the first to fourth slave devices in the configuration of FIG. 17 may be four power supply control devices 2.

### Fifth Example

A fifth example will be described. Although the technique according to the disclosure has been described assuming that the power supply device 1 is a composite power supply device capable of generating output voltages V_{OUT} for multiple channels, the power supply device 1 may also be a device that generates an output voltage V_{OUT} for one channel only. That is, the value of n described above may be “1”. The various techniques described above may be applied to the power supply device 1 with “n=1”. However, the methods MTD2 and MTD3 shown in the fourth example are effective only in the case where “n≥2”.

### Sixth Example

A sixth example will be described. In the sixth example, modifications or supplementary matters for the various techniques described above will be described.

The power supply control device 2 is a type of semiconductor device. Although examples of applying the technique according to the disclosure to a semiconductor device related to power supply control have been described, the technique according to the disclosure including the technique of setting the operation mode may also be applied to any semiconductor device (a motor driver, an LED driver, a high-side switch, a low-side switch, etc.).

For any signal or voltage, without compromising the gist described above, the relationship between high level and low level thereof may be reversed from that described above.

The types of channels of FETs (field effect transistors) shown in the above embodiment are exemplary. Without compromising the gist described above, the type of channel of any FET may be changed between the P-channel type and the N-channel type.

As long as no inconvenience arises, any transistor described above may be of any type. For example, any transistor described above as a MOSFET may be replaced with a junction FET, an IGBT (insulated gate bipolar transistor), or a bipolar transistor, as long as no inconvenience arises. Any transistor includes a first electrode, a second electrode, and a control electrode. In an FET, one of the first and second electrodes is a drain and the other is a source, and the control electrode is a gate. In an IGBT, one of the first and second electrodes is a collector and the other is an emitter, and the control electrode is a gate. In a bipolar transistor that is not an IGBT, one of the first and second electrodes is a collector and the other is an emitter, and the control electrode is a base.

The embodiment of the disclosure may be appropriately modified in various manners within the scope of the technical concept indicated in the claims. The above embodiment is simply an example of the embodiment of the disclosure, and the meanings of the terms of the disclosure or each constituent element are not limited to those described in the above embodiment. The specific numerical values shown in the above description are simply exemplary, and may naturally be changed to various numerical values.

### Appendix

The following appendix is provided for the disclosure for which specific configuration examples have been shown in the above embodiment.

A semiconductor device (2) according to an aspect of the disclosure includes: an internal power supply circuit (20) configured to generate an internal power supply voltage (V_{REG}) based on an input power supply voltage (VCC); a function circuit (30) configured to operate based on the internal power supply voltage; a chassis (CS) accommodating the internal power supply circuit and the function circuit; a specific terminal (REG) that is a terminal exposed from the chassis and is configured to be applied with the internal power supply voltage; and a mode setting circuit (40) configured to set an operation mode of the function circuit according to a terminal current (I_{EX}) flowing through the specific terminal (first configuration).

Accordingly, the burden of manufacturing and inventory management can be reduced compared to the first reference method described above, and reduction in the component size and cost can be expected compared to the second reference method described above.

In the semiconductor device according to the first configuration, after a generation operation of the internal power supply voltage by the internal power supply circuit begins, the mode setting circuit may operate based on the internal power supply voltage to generate a determination signal (MD) corresponding to the terminal current, and thereafter the function circuit may start up in the operation mode corresponding to the determination signal (second configuration).

Accordingly, a determination signal corresponding to the terminal current can be generated without being affected by the consumption current of the function circuit after the startup of the function circuit.

In the semiconductor device according to the second configuration, the internal power supply circuit may include an output transistor (21) provided between the specific terminal and a power supply terminal (IN) configured to receive the input power supply voltage, and control an output current (Ia) flowing to the output transistor such that the internal power supply voltage is stabilized at a specific voltage. The terminal current may flow through the output transistor and the specific terminal. The mode setting circuit may set the operation mode of the function circuit based on the output current at a determination timing (t3) after beginning of the generation operation of the internal power supply voltage and before startup of the function circuit (third configuration).

In the semiconductor device according to the third configuration, the mode setting circuit may set the operation mode of the function circuit based on a reference current (Ib) corresponding to the output current at the determination timing (fourth configuration).

In the semiconductor device according to the fourth configuration, the mode setting circuit may include a sense transistor (41) that constitutes a current mirror circuit together with the output transistor. The reference current may be a current flowing to the sense transistor and proportional to the output current (fifth configuration).

In the semiconductor device according to any one of the first to fifth configurations, the mode setting circuit may set the operation mode of the function circuit by determining whether an external resistor (R_{EX}) is connected between the specific terminal and ground outside the semiconductor device according to the terminal current (sixth configuration).

Accordingly, switching of the operation mode can be performed based on whether the external resistor is provided.

In the semiconductor device according to any one of the first to fifth configurations, the mode setting circuit may set the operation mode of the function circuit according to the terminal current which depends on a magnitude of a resistance component between the specific terminal and ground outside the semiconductor device (seventh configuration).

Accordingly, switching of the operation mode can be performed based on whether the external resistor is provided, or based on the value of the external resistor in the case where the external resistor is provided.

In the semiconductor device according to any one of the first to seventh configurations, the semiconductor device may be a power supply control device (2) configured to control an operation of a power supply device (1). The power supply device may include regulators (4) of multiple channels and execute power conversion of generating an output voltage (V_{OUT}) from an input voltage (V_{IN}) for each channel, and the power conversion may be controlled by the function circuit for each channel (eighth configuration).

In the semiconductor device according to the eighth configuration (refer to the method MTD1), the mode setting circuit may set the operation mode of the function circuit to any one of multiple modes including a first mode and a second mode according to the terminal current. The function circuit may cause the output voltage of the regulator of a specific channel to differ between the first mode and the second mode (ninth configuration).

In the semiconductor device according to the eighth configuration (refer to the method MTD2), the mode setting circuit may set the operation mode of the function circuit to any one of multiple modes including a first mode and a second mode according to the terminal current. The function circuit may begin power conversion by the regulator of a second channel after beginning power conversion by the regulator of a first channel in one mode of the first mode and the second mode, and begin the power conversion by the regulator of the first channel after beginning the power conversion by the regulator of the second channel in the other mode of the first mode and the second mode (tenth configuration).

In the semiconductor device according to the eighth configuration (refer to the method MTD3), the mode setting circuit may set the operation mode of the function circuit to any one of multiple modes including a first mode and a second mode according to the terminal current. The function circuit may execute power conversion by the regulator of a specific channel in one mode of the first mode and the second mode, and stop power conversion by the regulator of the specific channel in the other mode of the first mode and the second mode (eleventh configuration).

In the semiconductor device according to the eighth configuration (refer to the method MTD4), the mode setting circuit may set the operation mode of the function circuit to any one of multiple modes including a first mode and a second mode according to the terminal current. In a communication between the semiconductor device and another device, the function circuit may perform the communication recognizing that an address assigned to the semiconductor device is a first address in the first mode, and perform the communication recognizing that the address is a second address in the second mode (twelfth configuration).

In the semiconductor device according to any one of the first to seventh configurations (refer to the fifth example), the semiconductor device may be a power supply control device configured to control an operation of a power supply device (1). The power supply device may execute power conversion of generating an output voltage (V_{OUT}) from an input voltage (V_{IN}), and the power conversion may be controlled by the function circuit (thirteenth configuration).

In the semiconductor device according to the thirteenth configuration, the mode setting circuit may set the operation mode of the function circuit to any one of multiple modes including a first mode and a second mode according to the terminal current. The function circuit may cause the output voltage to differ between the first mode and the second mode (fourteenth configuration).

In the semiconductor device according to the thirteenth configuration, the mode setting circuit may set the operation mode of the function circuit to any one of multiple modes including a first mode and a second mode according to the terminal current. In a communication between the semiconductor device and another device, the function circuit may perform the communication recognizing that an address assigned to the semiconductor device is a first address in the first mode, and perform the communication recognizing that the address is a second address in the second mode (fifteenth configuration).

What is claimed is:

1. A semiconductor device comprising:
an internal power supply circuit configured to generate an internal power supply voltage based on an input power supply voltage;
a function circuit configured to operate based on the internal power supply voltage;
a chassis accommodating the internal power supply circuit and the function circuit;
a specific terminal that is a terminal exposed from the chassis and is configured to be applied with the internal power supply voltage; and
a mode setting circuit configured to set an operation mode of the function circuit according to a terminal current flowing through the specific terminal.

2. The semiconductor device according to claim 1, wherein
after a generation operation of the internal power supply voltage by the internal power supply circuit begins, the mode setting circuit operates based on the internal power supply voltage to generate a determination signal corresponding to the terminal current, and thereafter the function circuit starts up in the operation mode corresponding to the determination signal.

3. The semiconductor device according to claim 2, wherein
the internal power supply circuit comprises an output transistor provided between the specific terminal and a power supply terminal configured to receive the input power supply voltage, and controls an output current flowing to the output transistor such that the internal power supply voltage is stabilized at a specific voltage,
the terminal current flows through the output transistor and the specific terminal, and
the mode setting circuit sets the operation mode of the function circuit based on the output current at a determination timing after beginning of the generation operation of the internal power supply voltage and before startup of the function circuit.

4. The semiconductor device according to claim 3, wherein
the mode setting circuit sets the operation mode of the function circuit based on a reference current corresponding to the output current at the determination timing.

5. The semiconductor device according to claim 4, wherein
the mode setting circuit comprises a sense transistor that constitutes a current mirror circuit together with the output transistor, and
the reference current is a current flowing to the sense transistor and proportional to the output current.

6. The semiconductor device according to claim 1, wherein
the mode setting circuit sets the operation mode of the function circuit by determining whether an external resistor is connected between the specific terminal and ground outside the semiconductor device according to the terminal current.

7. The semiconductor device according to claim 1, wherein
the mode setting circuit sets the operation mode of the function circuit according to the terminal current which depends on a magnitude of a resistance component between the specific terminal and ground outside the semiconductor device.

8. The semiconductor device according to claim 1, wherein
the semiconductor device is a power supply control device configured to control an operation of a power supply device,
the power supply device comprises regulators of a plurality of channels and executes power conversion of generating an output voltage from an input voltage for each channel, and
the power conversion is controlled by the function circuit for each channel.

9. The semiconductor device according to claim 8, wherein
the mode setting circuit sets the operation mode of the function circuit to any one of a plurality of modes comprising a first mode and a second mode according to the terminal current, and
the function circuit causes the output voltage of the regulator of a specific channel to differ between the first mode and the second mode.

10. The semiconductor device according to claim 8, wherein
the mode setting circuit sets the operation mode of the function circuit to any one of a plurality of modes comprising a first mode and a second mode according to the terminal current, and
the function circuit begins power conversion by the regulator of a second channel after beginning power conversion by the regulator of a first channel in one mode of the first mode and the second mode, and begins the power conversion by the regulator of the first channel after beginning the power conversion by the regulator of the second channel in the other mode of the first mode and the second mode.

11. The semiconductor device according to claim 8, wherein
the mode setting circuit sets the operation mode of the function circuit to any one of a plurality of modes comprising a first mode and a second mode according to the terminal current, and
the function circuit executes power conversion by the regulator of a specific channel in one mode of the first mode and the second mode, and stops power conversion by the regulator of the specific channel in the other mode of the first mode and the second mode.

12. The semiconductor device according to claim 8, wherein
the mode setting circuit sets the operation mode of the function circuit to any one of a plurality of modes comprising a first mode and a second mode according to the terminal current, and
in a communication between the semiconductor device and another device, the function circuit performs the communication recognizing that an address assigned to the semiconductor device is a first address in the first mode, and performs the communication recognizing that the address is a second address in the second mode.

13. The semiconductor device according to claim 1, wherein
the semiconductor device is a power supply control device configured to control an operation of a power supply device,
the power supply device executes power conversion of generating an output voltage from an input voltage, and
the power conversion is controlled by the function circuit.

14. The semiconductor device according to claim 13, wherein
the mode setting circuit sets the operation mode of the function circuit to any one of a plurality of modes comprising a first mode and a second mode according to the terminal current, and
the function circuit causes the output voltage to differ between the first mode and the second mode.

15. The semiconductor device according to claim 13, wherein
the mode setting circuit sets the operation mode of the function circuit to any one of a plurality of modes comprising a first mode and a second mode according to the terminal current, and
in a communication between the semiconductor device and another device, the function circuit performs the communication recognizing that an address assigned to the semiconductor device is a first address in the first mode, and performs the communication recognizing that the address is a second address in the second mode.
